(19) United States
(12) Patent Application Publication
(10) Pub. No.: US 2003/0097217 A1
(43) Pub. Date: May 22, 2003

(54) AVL software specifications

(76) Inventors: Charles Hilliary Wells, Redwood City, CA (US); Donald Thomas Meyer, Offallon, MO (US)

Correspondence Address: Charles H. Wells, 422 Lakeview Way, Redwood City, CA, 94062, US

(21) Appl. No.: 10/135,048

(22) Filed: May 1, 2002

Related U.S. Application Data
(60) Provisional application No. 60/289,016, filed on May 7, 2001.

(51) Int. Cl. G01C 21/34

(52) U.S. Cl. 701/204; 701/202; 340/995

(57) ABSTRACT

In the US, over 40,000,000 single occupant vehicles (SOV) commute each day, often spending 30 or minutes more in congestion. In the San Francisco Bay area alone, over 2,000,000 SOVs waste over 190,000 hours in congestion each day. This not only wastes highly productive time but also pollutes at much higher rates than while moving.

This invention is designed to reduce congestion by providing users with the means to avoid congestion combined with minimum time enroute. A wireless device (probe) (an example is a PalmVII or Palm i705, IPAQ with a wireless modem, . . . ) is used to collect position, speed, and direction using a GPS receiver. This information is transmitted wirelessly while en-route to a host computer. The host uses both real-time and historical data to determine the estimated time en-route (ETE) and estimated time of arrival (ETA) for multiple routes to the destination. The user can then make decisions about changing routes in real-time.

This invention specifically covers the methods and algorithms used on the probe to perform the calculations.

This application references the original Provisional Patent application No. 60/289,016 and is incorporated herein by reference.

### BACKGROUND OF THE INVENTION

The following paragraphs are intended to comply with 37 CFR 1.71 “Detailed description and specification of the invention”.

This patent describes one portion of system to collect data from a moving vehicle, transmit this to a host computer, and compute the estimated time of arrival and estimated time enroute, and transmit this to the vehicle. A companion patent disclosure (application Ser. No. 10/135,022) describes how calculations are performed on the host computer and communicated back to the vehicle. The archived data combined with real-time data are used to forecast the street speeds.

Any NMEA compatible GPS is connected to the PDA (the initial implementation is on a PalmVII). It is programmed to read NMEA messages from the GPS receiver, process this data for local display and transmit it to a host computer via wireless Internet protocols. The major functions of the PDA software are to: acquire data from the GPS, convert to desired user units, display computed data locally, transmit the GPS messages to the host computer, and receive wireless messages from the host computer.

1. A Typical Set of Hardware

The typical system consists of a Palm VII or i705, a smart GPS antenna (Garmin, Earthmate, Pharosgps, Talon, or others). For the PalmVII, an optional rechargeable mounting kit for the GPS/PDA unit could be used. RevolveDesign is one vendor who could supply the recharging mount for the unit. Currently (Apr. 11, 2001), the Navman GPS unit for the PalmVII appears to provide the best performance. This receiver includes a Li-ion battery and provides faster acquire times. The Palm i705 with the Navman GPS unit now appears to be the best choice (Jun. 26, 2002).

2.1 Architecture of the Code

The software running in the Palm OS is, called “AVL.” It is modular and includes: (1) GPS communication, (2) host communication, and (3) transmission algorithm. The transmission algorithm will be written so that it can be used in multiple hardware platforms and operating system environments.

One alternative is to write this module as a dll so it may be wrapped as an ActiveX object in a browser application, or loaded at run time from an executeable program. Note: (added Apr. 11, 2001) In the actual implementation, this goal was not achieved: the code is specific to the Palm OS. A WinCE device would be able to use this binary code.

A complimentary product includes client code downloaded to a laptop via wireless modem and a connection to an ISP. The the laptop browser will host the client code downloaded by the ASP. The client code will run in the laptop collecting data and sending it to the server ASP. The ASP will push data to an SQL database and retrieve data from the same database containing the new route.

2. Location Task

This task sends data to the host computer when the vehicle: (1) is at its origin, (2) stopped, (3) moving, and (4) at its destination. The objective is to send fewest messages of the shortest possible length. The goal was to use only 500 messages per month at a cost of $24 per month; however, in practice, this is enough, but Palm offers unlimited messages for $44.95 per month: this option will be used initially.

3.1 Initialization

The program, “AVL”, runs when the antenna is raised: no action by the user will be required to activate it. If the antenna has not been raised, a POS message will instruct the user to raise the antenna. The program will collect and store data from transmission at a later time if the antenna remains lowered.

The POS will send the message

“Raise the antenna to perform wireless transactions. Tap Cancel to stop this wireless transaction”

The software establishes a connection with the host computer. An sends an email message to the host that says,

Xxxx initiated “location” task

The host returns an email saying,

Host acks.

This establishes the wireless connection to the host server. This message is periodically sent to the host to insure it is still alive. The response is used to provide feedback to the user that the messages transmitted to the host are being received. In the event of an error, a message is displayed on the PalmVII screen indicating that the connect to the host is not working. Something like,

“Host connection lost, restart the “Fastcommute”

The com port is read to see if the GPS antenna is connected. If no connection is detected, a message is sent to the user. The GPS echos each command sent to it. This will be used to insure valid signals are coming from the GPS. Perhaps the ALM command can be sent to initialize the unit on power up and verify that good communications are being received from the GPS unit. The default message from the GPS is time, lat, lon, speed and direction (true); hence no special GPS antenna initialization is required. In future versions, we will want some of the special messages available from the GPS. The error message says:

“Check connections to GPS antenna, no signal!”

After establishing connections and verifying that the communications are noise free, the software reads the RS-232 port every second.

For the initial release only messages from the gps com port are displayed. The entire message from the GPS receiver will be displayed.

When valid GPS messages are received, they are wirelessly sent to the host computer. There is a means to turn the GPS receiver software on/off manually, even though it comes on automatically on power up.

A number of messages are sent to the host based on the position of the vehicle or inputs from the user, including:

Messages currently sent from are:

Position

Trip Start

Trip End

Trip Cancel

Learn Start

Learn End

Learn Cancel

Additionally, the software will automatically send a “stopped” message or “idle”.

This signifies to the host that the vehicle is not moving.

1.1.1. Position

Information about the vehicles “lat/lon, speed, course etc.

This is the only message currently understood by the host

Fields:

ID User ID

st Status

ut Time in UTC format—hh:mm:ss

ud Date in UTC format—dd/mm/yy

la Latitude—ddmm.mmmm

lah Latitude hemisphere—N or S

lg Longitude—dddmm.mmmm

lgh Longitude hemisphere—E or W

sp Speed in knots—0.0 to 1851.8

co Course in degrees true—000.0 to 359.9

mv Magnetic Variation in degrees—000.0 to 180.0

md Magnetic Variation direction—E or W

1.1.2. Location

This sends data about a new location to the host. These are sent as needed. Once sent, they are marked as sent to the host and will not be resent without some explicit trigger (message from the host, command from the user, etc.)

Fields:

ID User ID

name Location name

type Unsigned 8-bit type index.

city City

state State

desc Brief description

la Latitude—ddmm.mmmm

lah Latitude hemisphere—N or S

lg Longitude—dddmm.mmmm

lgh Longitude hemisphere—E or W

1.1.3. Trip Start

This message is sent at the beginning of each “known” trip.

Fields:

ID User ID

msg “TRIPSTART”

origin ID of the trip's origin location.

dest ID of the trips destination location.

trip ID of the trip.

1.1.4. Trip End

When the user arrives at the destination, this message is sent to the host.

Fields:

ID User ID

msg “TRIPEND”

trip ID of the trip.

1.1.5. Trip Cancel

If the user cancels the trip, this message is sent. If the user changes the trip after a Trip Start message has been sent, this will be sent to cancel the current trip, and a new Trip Start message will follow.

Fields:

ID User ID

msg “TRIPCANCEL”

trip ID of the trip.

1.1.6. Learn Start

Fields:

ID User ID

msg “LEARNSTART”

origin ID of the trip's origin location.

1.1.7. Learn End

Fields:

ID User ID

msg “LEARNEND”

1.1.8. Learn Cancel

Fields:

ID User ID

msg “LEARNCANCEL”

1.1.9. Weather

Light rain

Heavy rain

Light Snow

Heavy Snow

Freezing Rain

Sleet

Fields:

<TBD>

1.1.10. Road Condition

Good

Wet

Snow

Ice

Flooded

Debris

Fields:

<TBD>

1.1.11. Incident

Need Police

Need Ambulance

Need Fire

Accident observed (details . . . )

Fields:

<TBD>

3. Host to AVL

This will have the same content as the Palm→Host message, but it will be sent as “data” instead of an encoded URL, since I believe that we can send fairly arbitrary chunks of text and binary from the host to the Palm.

1.1.12. ETE

Contents:

Time (ete) for each potential route (three?)

1.1.13. Warning

This would contain text related to road conditions or hazards?

LIFO Algorithm

The wireless coverage for most PDA's is not complete in any area. There are areas within the stated coverage where the signals from the PDA are not getting through to the host computer. To handle these conditions the following buffering algorithm is used.

(1) an attempt to send the message is made, if a response is not received from the host computer in less than a pre-determined interval, the message is put in a “pending” queue.

(2) After each successful transmission, the queue is checked for entries, if any are present, the most recent message is transmitted. This is known as a LIFO (last-in first-out queue). This is very important in any real-time system.

Operations:

The vehicle can be in any one of four states, and from these states can make one of two transitions. The states are (1) Origin, (2) Stopped, (3) Moving, or (4) Destination. The Origin and Destination states are special cases of the stopped state. There are two state transitions: (a) the transition from stopped to started called Leaving and (b) the transition from moving to stopped called Arriving.

Thus there are 6 possible conditions each time the loop executes

The initial state will be Origin.

Assign an Index {1, . . . ,6} for use in a “Select Case” statement. The values assigned are Origin=1, Stopped=2, Leaving=3, Moving=4, and Arriving=5, Destination=6. Initially, Index=1.

Let R be a global constant in the “Location” task. The units of the message are degrees and minutes and decimal minutes. Thus the message field 3722,87663 means 37 degrees, 22.87663 minutes North latitude. The initial default value of R will be 0.02: this amounts to about 120 feet.

### State Transition Diagram

3.2 Main Program

The main program consists of a one second loop: At the top of the loop, it reads the RMC message and computes the distance moved in raw “minutes” and writes this to a property in an object called objVehicle.nowPosition. There is no requirement to transform this into feet or meters at this time. The object contains a number of properties including: time, lat, lon, speed, and direction fields: these are available via the (RMC) message from the GPS using the standard NMEA 0183 Version 2.0 GPS protocol. The property oldPosition contains the raw position data one second ago. The .nowPosition is filtered to compute the best estimate of the acceleration in the x direction (lat) and in the y direction (lon) in units of minutes. Acceleration in latitude and longitude, seconds since last message, and the “distance since last position are properties of the objVehicle. The acceleration estimate is used to help determine if a message should be sent.

Initialize at power on:

Initialize constants

Check validity of the GPS antenna (look at the configuration table and use the antenna parameters for that sensor)

Check communications with the host computer via email (or http clipped web).

With obj Vehicle

.oldPosition = .nowPosition
Index = 1
Initialize filter
Update properties in objVehicle

Select Case Index

Case 1 'Origin state'

Send “Origin” message ' this is used at the host
Send “Stopped” message ' somewhat redundant
Set Index = 2

Case 2 'Stopped state
'Check distance moved

If (.distancemoved > R) and (.speed > SpeedMin) then

Set Index = 3 'in last second moved out of stopped circle
at a speed greater than SpeedMin
{we might check here for acceleration greater than a
tolerance value, this means that the vehicle is moving
away from the stopped state, we would use the .acclat or
acclon properties to determine this}

Else

Set Index = 2 'this is not needed but makes code readable

Endif

Case 3 'Leaving action

Initialize filter 'this gives it faster response.
Set Index = 4
Start timer
Send Moving message

Case 4 'Moving state

If (.time > tol) then

Send “Moving message” 'send message anyway

Else

IF (||accLat_or_accLon|| > tol or (timer > X) then
IF (.DistanceMoved > R) and (.Speed > SpeedMin then

'{send message only if acceleration in lat or lon is outside a

tolerance band or if the timer threashold exceeds its tolerance, and if the
distance or speed exceeds a threshold. What this means is that a message is
transmitted only if there is a change in speed or direction, this is what we would
consider to be the most important part of the transmission algorithm}

Send “Moving message”

Endif
Else ' moving, but about to stop

{we might use deceleration here to help insure the

'arriving action is really taking place, ie .acclat or .acclon is less than -
dectolereance, then the vehicle is stopping}

Set Index = 5 'Going to the stopped state on the

next iteration

Endif

.oldPosition = .newPosition

Case 5 'Arriving action

Check if position is inside the Destination circle (use function

above)

If (position inside) then

Set Index = 6 'next iteration go to Destination state

Else

Set Index = 2 'next iteration will be in the stopped state

Endif

Case 6 ' Destination

Send “Destination message”
Set Index = 1 'Return to origin state

Case Else

End Select

Message examples:

“Moving: 134522 A 3722.87663 N 12245.23312 W 65.34 023.3 032700

“Stopped: 134522 A 3722.87663 N 12245.23312 W 65.34 023.3 032700

“Origin: 134522 A 3722.87663 N 12245.23312 W 65.34 023.3 032700

“Destination: 134522 A 3722.87663 N 12245.23312 W65.34 023.3032700

This message structure would be identical if using the clipped web application.

This algorithm should send a message each time arriving at a stopping point, each time leaving a stopping point, and every X seconds while moving if the distance is greater than the stopped radius, R or if the speed or the direction have changed greater than the tolerance. It should send a message on power up stating the Origin, and another message when arriving at the Destination. Note: the second field in the body of the message is either an A or a V. A means ok, V means suspect.

In the manual mode, the user would press the four buttons on the bottom of the PDA. Messages would be sent each time a button is pressed and the unit is in manual mode.

3.3 Message Structure

The address will be gps@outreach2.org and any other list of addresses needed.

Subject line will be, stopped, moving, origin, or destination

Body will be in the raw GPS form of time, status, lat,hemisphere (N or S) lon, hemisphere (E or W) speed, direction. Notice lat and lon are in units of degrees and decimal minutes, eg. 12245.12345 is 122 degrees, 45.12345 minutes. Units of speed will be knots (this will be converted to miles per hour or kilometers per hour at the host computer. Direction will be in degrees from true north, i.e. 0-360 leading zeros are normally transmitted so 10.5 degrees true is transmitted as 010.1.

| Field name | Units | Format |
|---|---|---|
| Time | UTC | hhmmss |
| Status | Character | A or V |
| Latitude | Degrees minutes | dddmm.mmmmm |
| Hemisphere | Character | N or S |
| Longitude | Degrees minutes | dddmm.mmmmm |
| Hemisphere | Character | E or W |
| Speed | Knots | xxx.x |
| Direction | Degrees true | xxx.x |
| Date | Day month year | ddmmyy |

Note:
these fields at the host will be converted in the correct units for the database link to Trapeze or other scheduling software. Also note that DGPS corrections will be made to each record before it is written to the database.

3.4 Demand messages

In the final released version, the buttons on the Palm VII should be programmed to send certain messages and to “Read” mail messages.

In most cases, any button press required is considered bad and causes Worker Union problems. Button 1 and Button 2 are probably the only ones really needed.

3.5 Watchdog Timer

A message from the host computer should be sent about every 30 seconds. This message is used to indicate to the user that communications with the host computer are ok. If after 30 seconds, there is no message from the host. An alarm should be made visible on the personalized web page for this user.

Filter Algorithm

This is the most proprietary part of the algorithm. We will use a moving polynomial filter to estimate the position, speed, direction, and acceleration. This algorithm is executed on both the Lat (y) and the Lon (x). This is a two dimensional (2D) algorithm, but since x and y are independent, we perform the calculations in 1 D at a time. Although speed and direction information is computed in the smart antenna, we will use the filtered values of these variables. This algorithm is not restricted to cubic polynomial nor to 8 points in the history array. Let's use a cubic polynomial in the form shown below.

f(t)=a+bt+ct²+dt³

f′(t)=b+2ct+3dt²

f″(t)=2c+6dt

@t=0

\hat{f}(0)=â

\hat{f}′(0)=\hat{b}

\hat{f}″(0)=2ĉ

where â,\hat{b},ĉ,\hat{d} are least squares estimates of the a,b,c,d,coefficients computed derived below and \hat{f}(0), \hat{f}″(0), \hat{f}″(0) .are the best estimates of the (x, y) , (dx/dt, dy/dt), and (d²x/dt²,d²y/dt²). Assume that time zero is the now time, then we may write

f(0)=a

f(−Δt)=a+b(−Δt)+c(Δt²)+d(−Δt³)

f(−2Δt)=a+b(−2Δt)+c(4Δt²)+d(−8Δt³)

f(−3Δt)=a+b(−3Δt)+c(9Δt²)+d(−27Δt³) (1)

There may be any number of “history” points in this set of equations, but we only have to find the inverse of a (4×4) matrix, which can be done off-line if Δt is constant, which is it in our case, =1 second.

This can be solved as follows: rewrite the above equations in vector matrix notation

f=Ap (2)

where f is a column vector of the past (n) number of measurements, A is the matrix of Δts and 1's, and p is the column vector of the unknown parameters.

The solution is given by

\hat{p}=[A^{T}WA]⁻¹A^{T}Wf, (3)

where W is the weighing matrix. The results are:

\hat{p}₁=\hat{f}(0)=â

\hat{p}₂=\hat{f}′(0)=\hat{b}

\hat{p}₃=\hat{f}″(0)=2ĉ

For more details, see the attached Excel spreadsheet showing how the calculations are performed. This sheet gives an example of measuring lat and lon every one second and using an 8 point moving polynomial filter. The estimator for the second derivative is very good as can be seen by running the Excel sheet in Monte Carlo mode. Using the 8 point filter, we need to store 24 fixed numbers, eight for each of position, velocity, and acceleration. The same 24 numbers are used for both the lat and the long estimates. This means we have to keep a rotating memory of the last 8 measurements of lat and lon. The oldest value is thrown out each time a new measurement is made. The filter is initialized by filling the history with the value of the first measurement when entering “State 4”.

We compute the filtered value of acceleration in both the lat and the long direction.

The transmission algorithm then uses the estimated acceleration to decide if a new message should be transmitted. We are really interested in knowing if either the speed or the direction is changing, since our end goal is to estimate the street speeds. This can be done by checking to see if the acceleration in either lat or long is changing, if it is, the speed is changing and hence we must transmit a new message. In a similar vein, if we are accelerating or decelerating, the message transmissions should be at a higher rate.

So the algorithm is as follows:

If (abs(.acclat) or abs(.acclon))<tol) then

Do not transmit a message

Else

Transmit a standard moving message if distance or speed change

Endif

Note that if the acceleration in lat or long is outside the tolerance bounds, then either speed or direction has changed and a new message is transmitted if needed.

User Interface Innovations:

Destination Calculation:

The destination algorithm is based on a psuedo-log. It does not track every trip separately, but tries to gather data we can use for smart destination prediction. It's working about 25% as well as I want it to right now. Primary goal was to get the data gathering mechanism in place—I can follow up with a smarter algorithm down the road.

o→d n(w at t) doc=z

o=Origin unique ID

d=Destination unique ID

n=Number of times we've done this trip

w=Day of the week (0=Sun, 6=Sat)

t=Tenths of an hour since midnight

z=Days since Jan. 1, 1904

When a new trip occurs, we look to see if it matches an existing trip within 4 hours and is the same day of the week. If so, that entries' trip count is incremented. Otherwise, we make a new entry.

This data is used to generate a ranked list of likely destinations, based on day of week, origin and time of day.

Proximity Detection Parameters:

A parameter can be set in the software defining the Origin or Destination error tolerance. This is an important setting since commuters often do not have assigned parking spots and the size of the lot depends on the number of employees. A small company may have a lot of 100 feet by 100 feet, whereas a large company will have a much larger lot. The software requires a point and a radius to define any location. The radius in the AVL system is a user defined parameter.

Retry Time Interval

As part of the algorithm responsible for sending the most recent messages from the PDA device to the host computer, a re-try time interval is specified. This is a critical parameter depending on the number of “holes” in the wireless network coverage, and the “load” on the network. In the present invention, this parameter is a constant set by the user; however, in a future embodiment of the system, and adaptive re-try interval will be used. The interval time will be increased as a function of the number of failures is getting a message through the network, and conversely, the re-try interval will be reduced as the number of “pending” messages goes to zero.

Gulp Size Parameter

Data from the GPS arrives asynchronously from an “unbuffered” serial port on the PDA device. The NMEA messages are embedded in the continuous ascii string. In order to make sure no messages are lost, the AVL software reads the serial port data into a memory buffer. The size of the buffer is adjustable. This allows for fine tuning of the software without reprogramming.

Handing of Units

Data from the GPS NMEA messages are in the Nautical unit system. Users in the US are familiar with the English system of units and European users are familiar with the SI system. The software handles this conversion in a common location providing the ability to change units from SI to English to Nautical in one common location.

Screen Selection Options

A serious problem when using handheld devices in an automobile is the user interaction with the device. The common method is to use the “stylus” to point and click to items of interest on the screen as well as special area of the screen for text and numbers as well as specific functions such as application, menu, etc.

The AVL program eliminates most requirements for the stylus by clever use of the hardware buttons on the PDA device. There are four buttons and one rocker button. The AVL program uses these in an intuitive way to allow the user to select “windows” of most interest to the user. A configuration page allows the user to select the screens of interest in a standard rotation, triggered by pressing one of the hardware buttons. This can be done without looking at the PDA unit, simply by feel; thus avoiding a distraction while driving. One of the innovative selection mechanisms is the use of the buttons immediately to the left and to the right of the rocker select switch. Pressing the left button brings a list of selected functions to the view surface including: Pick destination, Save Location, Start Trip, Cancel Trip, and Set Arrived. Other options could be placed on this screen. The user selects the desired function by toggling the rocker switch to highlight the item of interest. The selection process is via the right button. This performs the actual selection; i.e., the button to the right is the “action” button.

User Dialog for Picking a Destination

An innovative technique for selecting a new destination, saving a location, starting a trip, canceling a trip, or advising of an arrival at a destination. The recognition of the following states is largely automatic; but the hardware buttons allow one to change the state manually.

Destination Properties

Each location has a number of properties including: name, type, city, state, last time visited, distance from now, lat, long, date/time first defined, and a set of notes that can be associated with the destination.

Message Stats:

The message status information provides the user with the following information: number and time since bad connections, same for number of NMEA messages, valid messages, Network ok, and pending messages in the LIFO buffer.

Diaglog Records

Each attempt to communicate with network is recorded in an external file. This file is readable by a third program called DIAGLOG.

CUVN Error Messages:

The text string CUVN is used to convey to the user what might be wrong with the system.

Each letter can be either upper case=good, or lower case=bad. The meaning of the letters is as follows:

C=connectivity between the PDA and the GPS

U=understandable message structure from the GPS

V=a valid position is being transmitted

N=acknowledgment from the Network

Thus CUvN, means good connectivity to the GPS, U means understandable NMEA messages, v means invalid position, and N means network connectivity.

English Language Messages

Each of the above messages are written in words to a “Problem” screen. Additionally, messages such as low battery, antenna down, transmitter being recharge are show to help the user fix the problem.

Autonomous ETE Calculations

The unit includes five different methods of computing “street” distance. This is used in computing the ETA autonomously in the unit. The user can select the method that gives the best accuracy. Depending on the layout of the streets with respect to true north and the typical routes, the method selected will affect the accuracy.

The five methods are:

Straight Line

This is the great circle distance from the current latitude and longitude to the destination latitude and longitude.

Triangular

This is the sum of the length of the sides of a right triangle whose hypotenuse forms the straight line from the origin to the destination.

CARDINAL:

[symbol]

The delta between the current heading and the four cardinal headings (0, 90, 180, 270) is taken and used to generate four “triangular” distances. The shortest of these four distances is then taken as the distance for this calculation.

CARDINAL BEST:

[symbol]

The cardinal and triangular distances are calculated, and the shortest one of the pair is taken as the distance for this calculation.

Method 5.

From the host computer

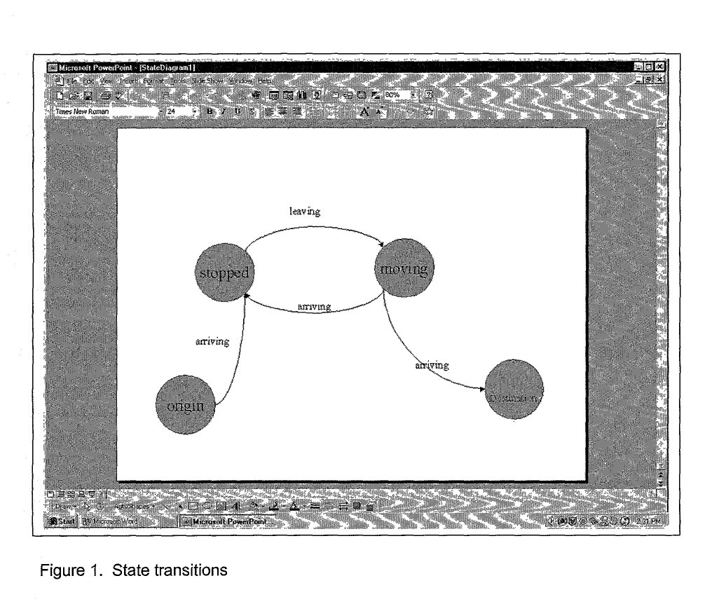

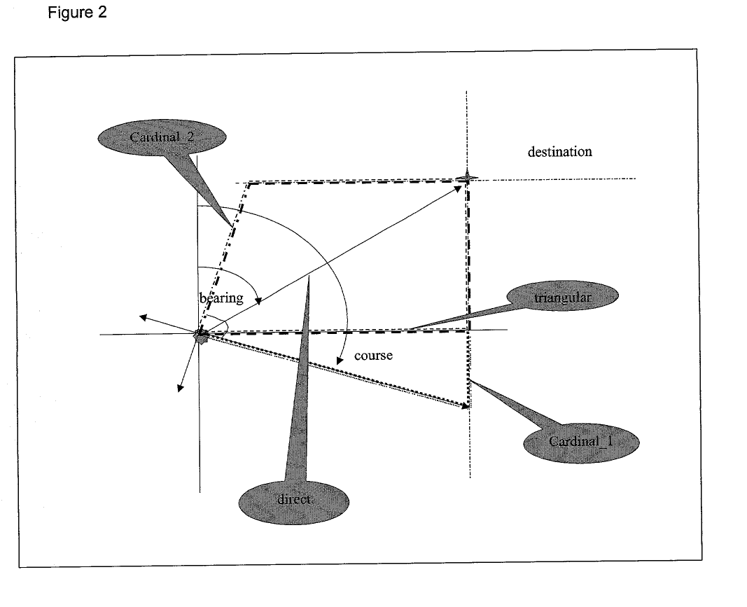

An alternate method is shown in FIG. 2.

☆

XY Charts

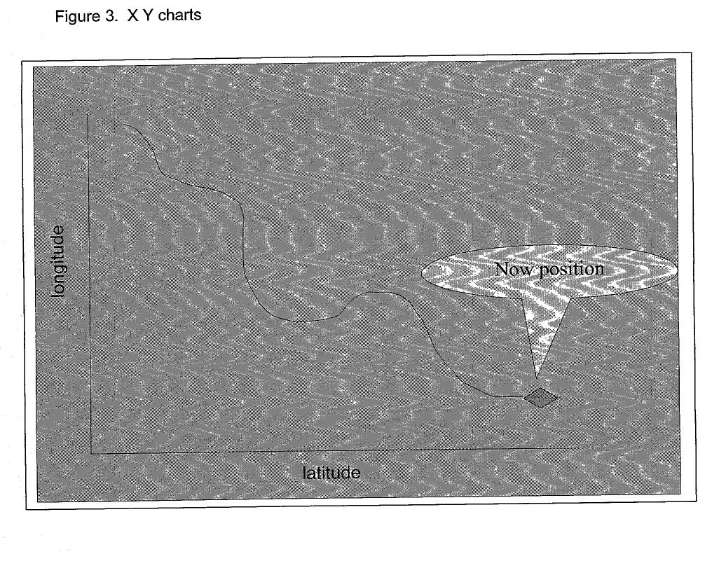

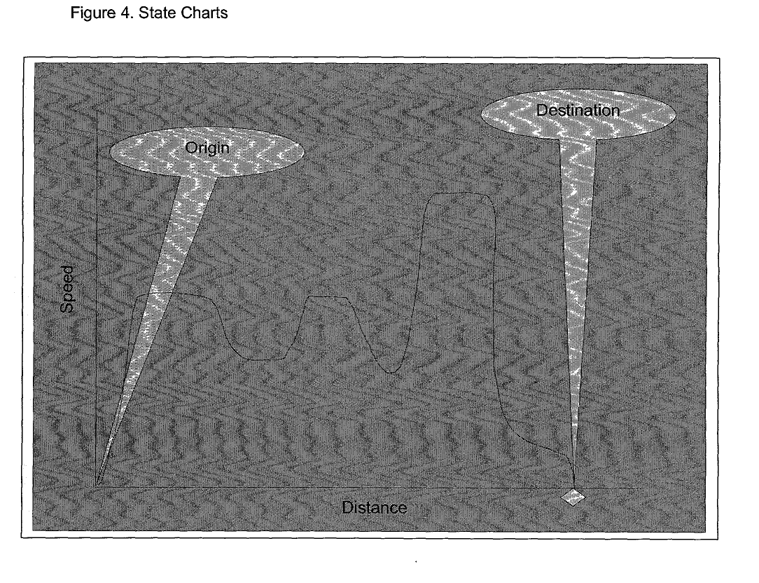

These charts are plots of latitude versus longitude. The plot consists of points of latitude and longitude at different times during the commute. The past could be shown in one color or line style and the future could be shown in a different color or line style. An example is shown in the figure FIG. 3:

State Charts

These charts can be used by commuters to quickly grasp the progress of their commute. This type of chart shows distance and speed, with speed on the y axis. The XY chart clearly shows progress along the route and the State chart shows progress relative to distance from the origin. Both represent innovative methods of displaying progress on the commute.

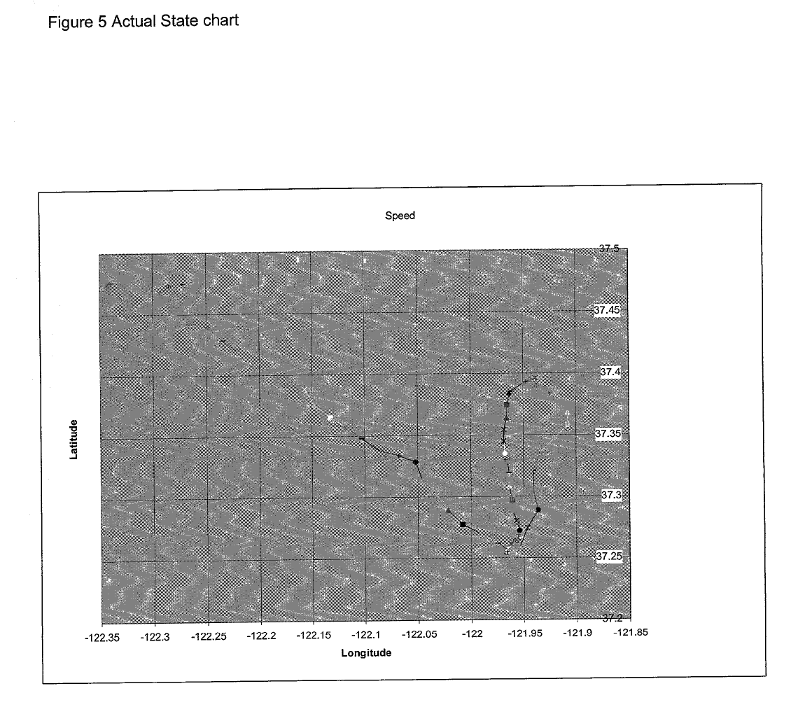

Examples from an actual commute are shown in FIG. 5:

1) method to estimate when to transmit a position message to the host

2) method of buffering messages and sending them with the most recent first

3) method of recognizing when a vehicle has reached it destination, when it is moving, and when it is idle.

4) Method of estimating the preferred destination of a vehicle

5) Method of continually attempting to send messages to the host computer

6) Method of processing the character stream from the GPS

7) Method of converting and displaying units of customer choice

8) Method and implementation of selecting information screens from a list and selecting them in rotation by pressing a “hard” button

9) User interface to select a destination from a list

10) Method of entering properties of the destination

11) Method of displaying time dependent data regarding the wireless portion of the PDA

12) Error logging function for diagnostics

13) Method of displaying error messages

14) English language method of displaying messages

15) ETA calculation options.

16) Method of displaying “State charts”

17) Method of displaying XY diagrams, with time as a parameter
